(19) United States
(12) Patent Application Publication
(10) Pub. No.: US 2008/0282661 A1
(43) Pub. Date: Nov. 20, 2008

(54) Paddle assembly for corn-head sweeper

(75) Inventors: Douglas K. Gengenbach, Lexington, NE (US); Stephen Wahls, Loomis, NE (US)

Correspondence Address: VINCENT L. CARNEY LAW OFFICE, P.O. BOX 80836, LINCOLN, NE, 68501-0836, US

(73) Assignee: DMG Equipment, LLC, Lexington, NE (US)

(21) Appl. No.: 12/151,685

(22) Filed: May 8, 2008

Related U.S. Application Data
(60) Provisional application No. 60/930,256, filed on May 14, 2007.

(51) Int. Cl. A01D 45/02; B21K 19/00

(52) U.S. Cl. 56/119; 29/891

(57) ABSTRACT

A sweeper for a corn harvester includes self-gripping paddle assemblies mounted about a drive axle. The self-gripping paddle assemblies have a plurality of paddles formed of flat plate stock with a high moment of inertia formed by stiffeners extending from the flat plate. The stiffener plates are orthogonal to the axis of the drive axle and to the base plate. The orthogonal plates have curved surfaces formed such that when the paddles are connected together, the curved surfaces grip the drive axle. One embodiment of paddle assemblies is foldable and one embodiment of paddle is formed to permit easy stacking one inside of the other for shipment

### RELATED CASES

This application is a continuation-in-part of U.S. provisional patent application 60/930,256 filed May 14, 2007, by inventors Douglas K. Gengenbach, et al. The benefit of the filing date of provisional patent application 60/930,256 is claimed.

### BACKGROUND OF THE INVENTION

This invention relates to paddle assemblies for corn-head sweepers.

It is known to attach a sweeper to a combine that is equipped with a corn head for harvesting corn. The sweeper includes a drive axle with paddles spaced along it. A drive motor rotates the drive axle to which the paddles are attached which in turn orbits the paddles about the drive axle. The drive axle and paddles are positioned to remove debris during harvesting. A prior art sweeper having these characteristics is described in U.S. Pat. No. 6,672,042, the disclosure of which is incorporated herein by reference.

One prior art sweeper of this type includes paddle assemblies, each of which includes a hub and paddles as described in the above mentioned U.S. Pat. No. 6,672,042. The hub is coaxial with and fastened to the drive axle and the paddles are fastened with the hub. The paddles are flat plates or vanes extending radially from and being directly mounted to the hub. The paddles are in planes parallel to the longitudinal axis of the drive axle and are braced against each other by triangular-centrally located flat plates between the paddles.

The prior art paddle assemblies have several disadvantages, such as for example: (1) they are more complicated and expensive than desired; (2) they have a lower moment of inertia than desired and thus a lower strength than desired for the amount of material and weight included in them; (3) they are expensive to manufacture; (4) they must be positioned on the axle of the drive mechanism by moving the opening in the hub over one end of the axle and sliding the paddle into position; and (5) they are expensive to pack and ship.

Another embodiment of prior art paddle assembly is formed in two identical sections that may be bolted together over the axle. Each section includes a clamp half, a post and a flat base plate. The clamp half is a half cylinder with a flange on each end. The post extends from the center of the half cylinder. The flanges have openings to permit two half cylinders to be bolted together around the axle with their inner cylindrical surfaces engaging the axle to permit orbiting of the posts with rotation of the axle. The posts each include a slot and the flat base plate is inserted in the slot so that the flat base plate is orbited with the post and the axle.

This prior art paddle assembly also has several disadvantages, such as for example: (1) it is more complicated and more expensive than desired; (2) it has a lower moment of inertia and thus a low strength for the amount of material and weight included in it; (3) it is expensive to manufacture; (4) it is subject to damage unless it is thick because of the leverage imposed by forces at the ends of the flat base plate; and (5) it is expensive to pack and ship.

The prior art sweepers include a continuous drive axle to which the paddle assemblies are mounted. This sweeper has a disadvantage in that it cannot accommodate as many paddles or as long a length of paddles as desired for some applications. If a longer length of axle were incorporated, it would cause difficulty in moving the combine from location to location because of obstructions on either side of the roadway that may not leave a sufficiently wide path. Moreover, the longer length is an inconvenience when the sweeper is being packaged such as for shipment. While the prior art paddle assemblies serve to move most of the corn into the combine, there is a tendency for fluff to gather at the center portion of the combine.

### SUMMARY OF THE INVENTION

Accordingly, it is an object of the invention to provide a novel sweeper for corn harvesting equipment.

It is a further object of the invention to provide a novel paddle assembly for a corn-head sweeper.

It is a still further object of the invention to provide a novel method of making a paddle assembly for a sweeper.

It is a still further object of the invention to provide a novel hubless paddle assembly.

It is a still further object of the invention to provide a novel paddle assembly that is inexpensive, easily assembled to a corn sweeper and adjustable in position on the sweeper.

It is a still further object of the invention to provide a novel foldable corn-head sweeper.

It is a still further object of the invention to provide a novel self-gripping paddle assembly.

It is a still further object of the invention to provide a novel corn-head sweeper that can be conveniently packed for shipping.

It is a still further object of the invention to provide a novel single-walled paddle.

It is a still further object of the invention to provide a paddle assembly with a unitary body design.

It is a still further object of the invention to provide a paddle for a corn-head sweeper that is made of formable sheet material.

In accordance with the above and further objects of the invention, a sweeper for a corn head includes a drive mechanism and a plurality of paddle assemblies. The drive mechanism includes an axle that rotates the paddle assemblies in a manner to reduce the tendency for debris to accumulate in the corn head and impede its operation. The axle and paddle assemblies can be positioned with respect to the corn head to operate under different field conditions such as when harvesting corn that has been knocked over by weather or which is standing. The paddle assemblies are preferably self-gripping.

The individual paddle assemblies or parts of a paddle assembly are preferably of a single thickness and formed easily such as by stamping and folding or injection molding. They have load-bearing walls supported by stiffener plates at an angle to them and preferably spaced from their axes to have a high moment of inertia about the axis of rotation. Preferably they are single-walled, self-gripping paddles formed of formable sheet material and having a unitary body design. In one embodiment, the axle may be folded. In other embodiments, the axle is in sections that are fastened to each other such as by screwing the end of one externally threaded section into another section having an opening with complementary internal threads. Further economies may be obtained in a preferred embodiment by making paddles so that they fit one into the other for packing and shipping. Fox example they may have side walls that are perpendicular to flat load bearing or axle gripping and spacing walls to form shell like structures that fit one into the other.

In this specification, the terms “self-gripping paddle assembly” means any device that may be positioned in a combine fitted with a corn head to prevent debris from impeding the operation of the corn head but which may be connected to an axle of a drive mechanism at any of a plurality of locations between the ends of the axle without the need for gaining access to the ends of the axle. It does not include devices that have a hub with an integrally formed unbroken internal wall that engages the axle. After the sweeper is assembled to a harvester, the paddles, with this embodiment may be fastened about the axle at the appropriate locations so that they may be fastened without dismantling. Moreover, if a paddle becomes worn or broken or an additional paddle is needed or not required, the paddles may be added, replaced or removed without disassembling the rest of the sweeper.

The self-gripping paddle assembly may have any shape such as flat or hollow with a flat surface facing the direction of rotation or may be bar shaped or may have any other shape capable of removing debris. It may be flexible or rigid or made of any suitable material. It may include one part or a plurality of parts and each or some of the parts of the plurality of parts may be separately directly fastened to the axle or the plurality of parts, when fastened together, may grip the axle. If there are multiple parts, they may be identical or different from each other and parts may be positioned rigidly with respect to each other or be movable with respect to each other such as being foldable with respect to each other or the like. In this specification, it may include one or more self-gripping paddles.

In this specification, “single-walled paddles” means paddles formed of metal, plastic or other suitable material without wall portions extending transverse to other wall portions other than at edges where the transverse wall portions are bent. In single-walled paddles, the paddle base plates and stiffener plates are transverse wall portions and are bent from substantially the same thickness of material. Similarly, in this specification, “self-gripping paddle” means a single-walled paddle for a corn-head sweeper that either alone or with other self-gripping paddles can grip a drive axle at any location on the axle by forming a clamp at the location without gaining access to the ends of the axle. This is in contrast to sliding a hub of a paddle with continuous unbroken internal walls over the end of the axle so that the internal walls encircle the axle.

In this specification, the term “formable sheet material” means any suitable material that can be formed into stiffener plates, paddle base plate, gripping surfaces, and facing mounting plates of the paddles that are the subject of the embodiments of this invention. Generally they are sheet metal or inexpensive plastics that can be formed into the desired shape by conventional methods. In the preferred embodiment, some formable sheet materials are metal that may be bent into the desired shape or PVC formed by pressure molding into component parts. However, any other suitable formable sheet material can be used as well.

In one embodiment of assembly, additional stiffener plates such as central stiffener plates may be added. This type of paddle assembly is not a single-walled paddle but is a single thickness paddle. In this specification, “single thickness paddle” means a paddle that is a unitary body designed paddle in which all parts of the paddle are walls with substantially the same thickness. The base plates may include apertures permitting the attachment of a second base plate when desired. The second base plate may have a longer length and a different shape to extend the coverage of the paddle. Moreover, it adds stiffness to the paddle when that is required.

Still another embodiment of paddle assembly has a different shape and may include a different number of paddles extending from the central hub. This type of paddle is designed to be centered over the corn head and is shorter so that it does not extend between corn heads but rotates above them to remove fluff and scoop it into the center of the auger.

From the above description, it can be understood that the self-gripping paddle assembly of this invention has several advantages, such as for example: (1) it may be quickly and easily assembled to a drive mechanism; (2) it does not require a separate fastening hub that is connected to the drive mechanism; (3) the individual parts may be easily manufactured because of their simplicity; (4) the paddles are structurally strong with a high moment of inertia; (5) the parts may be conveniently packed for shipment with other parts of the sweeper, some of which may also be dismantled; (6) the assembly may be part of a retrofitted design for a corn harvester; and (7) the paddles may be easily assembled about an axle of the sweeper without disassembling the sweeper.

### BRIEF DESCRIPTION OF THE DRAWINGS

The above noted and other features of the invention will be better understood from the following detailed description when considered with reference to the accompanying drawings, in which:

FIG. 1 is a fragmentary, perspective simplified view of a combine and corn head combination with the paddle assembly of this invention mounted to it;

FIG. 2 is an exploded perspective view of a self-gripping paddle assembly positioned with respect to a drive axle in accordance with an embodiment of the invention;

FIG. 3 is a simplified perspective view of the self-gripping paddle assembly of FIG. 2 shown assembled but without the drive axle;

FIG. 4 is a simplified perspective view of a single paddle usable in the embodiment of FIG. 2;

FIG. 5 is a simplified perspective view of the paddle of FIG. 4 viewed from another direction;

FIG. 6 is a simplified perspective view of still another embodiment of the invention;

FIG. 7 is a plan view of a steel blank form from which an embodiment of the invention may be formed;

FIG. 8 is simplified perspective view of a corn-head sweeper having a self-gripping paddle assembly in accordance with an embodiment of the invention;

FIG. 9 is a simplified perspective view of another self gripping paddle assembly in accordance with an embodiment of the invention;

FIG. 10 is a simplified perspective view of a self gripping center paddle assembly;

FIG. 11 is a simplified perspective view of another embodiment of corn-head sweeper that is foldable in accordance with an embodiment of the invention;

FIG. 12 is another simplified perspective view of the corn-head sweeper of FIG. 11 folded in another position;

FIG. 13 is another simplified perspective view of the corn-head sweeper of FIG. 11 mounted to a corn head and viewed from another angle;

FIG. 14 is still another simplified perspective view of the corn-head sweeper of FIG. 11 mounted to a corn head and viewed from still another angle;

FIG. 15 is still another simplified perspective view of the corn-head sweeper of FIG. 11 mounted to a corn head and viewed from another angle;

FIG. 16 is a fragmentary flow diagram illustrating the principal novel steps of making and using a novel corn-head sweeper of this invention; and

FIG. 17 is a fragmentary flow diagram illustrating the principal novel steps of making and using another embodiment of com-head sweeper of this invention.

### DETAILED DESCRIPTION

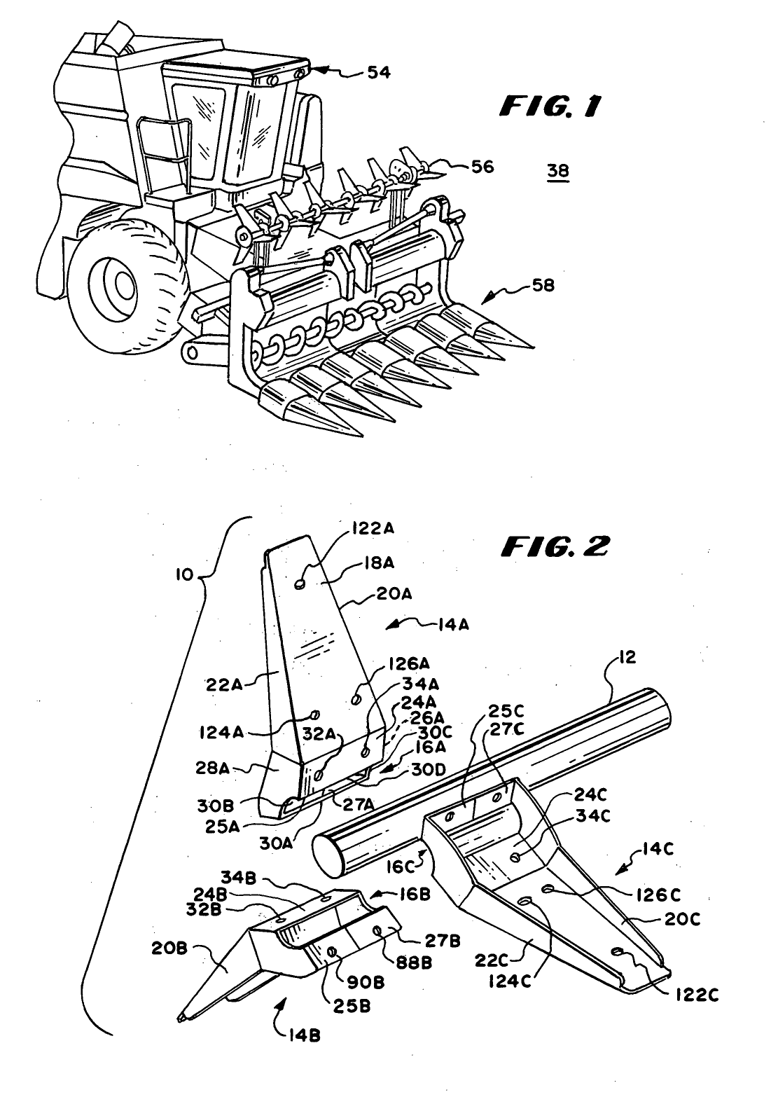

In FIG. 1, there is shown a fragmentary, perspective simplified view of the combination 38 of a combine 54, a corn head 58 attached thereto and one embodiment 56 of com-head sweeper that incorporates a novel paddle assembly in accordance with the invention. This embodiment 56 of com-head sweeper is shown in FIG. 1 raised in its inactive position from which it may be lowered to sweep debris from the corn head 58. The com-head sweeper 56 incorporates self-gripping paddle assemblies with single-walled paddles in a unitary body design, each of which grips an axle for rotation therewith when the com-head sweeper is lowered and actively sweeping. To raise the corn-head sweeper 56 to the position shown in FIG. 1, sweeper arms holding the paddle assemblies are articulated in such a manner that the axle and paddle assemblies are located in a position where the operator of the combine has good vision and the com-head sweeper is raised above the corn head.

In some embodiments, the axle may be folded to reduce the length of the axle and provide more clearance on the side of the combine. In some embodiments, the axle is in sections that are fastened to each other such as by screwing the end of one externally threaded section into another section having an opening with complementary internal threads. Certain economies are obtained in a preferred embodiment by making paddles so that they fit one into the other for packing and shipping. Fox example, they may have side walls that are perpendicular to flat load bearing or axle gripping and spacing walls to form shell like structures that fit one into the other.

In this specification, the term, “unitary body design” means a design in which strength is obtained by bent, angled, transverse, intersecting or curved portions creating a high moment of inertia rather than by increasing the thickness of the parts. The load-bearing members are strengthened by the bent, transverse, intersecting, angled or curved members on their sides and/or between sides that provide resistance to bending of the ends of the load bearing members. Preferably, no wide area of load bearing paddle extends a substantial distance beyond one of the bent, angled, transverse intersecting or curved portions. Generally, the unitary body designed paddles are made of formable sheet material and in the preferred embodiment, the sheet material is steel or aluminum. However, plastic may be used.

In FIG. 2, there is shown a simplified exploded perspective view of a self-gripping paddle assembly 10 mounted to an axle 12 of a drive mechanism (not shown in FIG. 2). In the preferred embodiment, the axle 12 is driven by a conventional motor-belt arrangement (not shown in FIG. 2). However, any other suitable drive mechanism or element of a drive mechanism including gear type transmissions may be used instead. Advantageously, the individual self-gripping paddle assemblies 10 may be easily mounted in different locations and may have different configurations to accommodate the field being harvested. In this specification, the word “transmission” means any connection direct or indirect that drives the corn-head sweeper or any portion of the corn-head sweeper in response to the action of a motor. The motor may be any type of motor such as hydraulic or electrical and may be located either as part of the sweeper or separately from the sweeper. It may receive power from any source.

In the embodiment of FIG. 2, the axle 12 is a solid cylinder adapted to be engaged by curved portions of the self-gripping paddle assembly 10 but can be other shapes and can be tubular instead of solid. The self-gripping paddle assembly 10 includes three paddles 14A-14C but other embodiments may include a different number of paddles and, while the paddles 14A-14C are identical to each other in the embodiment of FIG. 2, they need not be identical. Each of the paddles 14A-14C of the self-gripping paddle assembly 10 has a corresponding one of gripping portions 16A-16C which cooperate together when the paddle assemblies are fastened about the axle 12 to grip the axle 12 at a selected location for movement with the axle 12.

Because each of the paddles 14A-14C in the embodiment of FIG. 2 is identical, only the paddle 14A will be described in detail. The other paddles 14B and 14C have numbers corresponding to those of the paddle 14A except they are followed by the corresponding prefixes B or C as appropriate rather than A.

To form a rigid strong load bearing member that grips the axle 12 and is orbited by the axle 12 as the axle 12 rotates, the paddle 14A includes a relatively flat trapezoidal shaped base plate 18A, four stiffener plates 20A, 22A 26A and 28A and three fastener plates 24A, 25A and 27A. The trapezoidal shaped base plate 18A is orbited with the axle 12 to remove material that otherwise could clog the corn head 58 (FIG. 1). The stiffener plates 20A and 22A are orthogonal and serve as stiffeners for the base plate 18A and thus enables a thinner metal base plate or a base plate of less sturdy material or lower modulus of elasticity to be used. The flat trapezoidal base plates such as 18A includes three holes or openings such as 122A, 124A and 126A which may be used to bolt on an additional plate as described hereinafter to increase the size of the paddle.

To provide gripping surfaces, the side stiffener plates 28A and 26A have parallel curved edges 30B and 30C orthogonal to the axis of the axle 12 and parallel straight edges 30A and 30D aligned with the axis of the axle 12. The straight edges 30A and 30D, together with the corresponding curved edges 30B and 30C, form the gripping portion 16A shaped to conform to the surface of the axle 12. The paddle 14A grips the axle 12 in cooperation with the two other paddles 14B and 14C. A similar group of curved surfaces forms the other parts of the gripping surfaces. Of course, if the paddles 14A-14C have gripping surfaces that are not parts of a cylindrical surface, then the drive axle 12 will have a different cross sectional shape that conforms to the shape formed by the gripping portions 16A-16C of paddles 14A-14C. For example, the axle may be hexagonal in cross section and the edges 30B and 30C may be straight and form right angles with each other.

The flat fastener plates 24A, 25A and 27A include fasteners such as bolt openings for fastening the paddles 14A-14C together. In the preferred embodiment, fasteners are bolt holes 32A and 34A in fastener plate 24A and bolt holes 88A and 90A in fastener plates 27A and 25A respectively (holes 88A and 90A are not labeled in FIG. 2; shown in FIG. 5). These holes are arranged to be aligned with holes on the paddles 14C and 14B to be bolted together in a gripping relationship with the drive axle 12. The side stiffener plates 26A and 28A have curved edges 30B and 30C that are aligned with and engage corresponding curved edges on the paddles 14B and 14C to grip the axle 12.

The flat trapezoidal shaped base plate 18A, the stiffener plates 20A and 22A, the fastener plates 24A, 25A and 27A and the side stiffener plates 26A and 28A on opposite sides are the same thickness and formed from the same flat piece in the preferred embodiment. Together, the flat plates provide a rigid, strong, unitary body design that can be inexpensively formed out of flat stock.

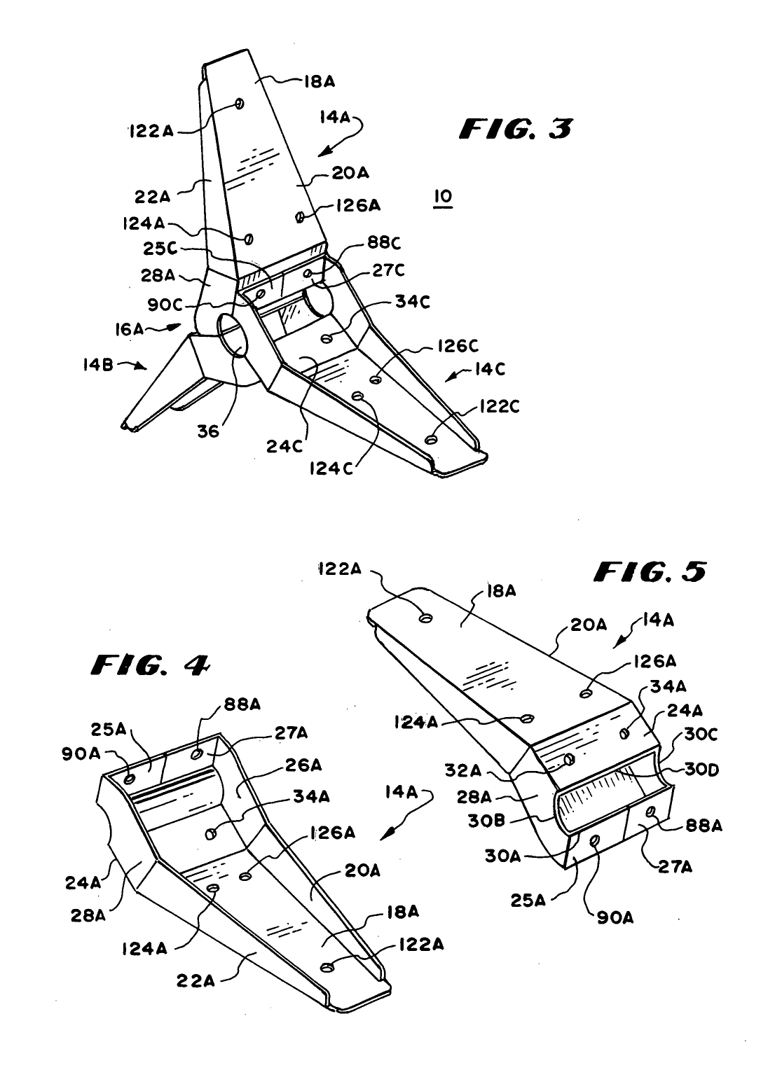

In FIG. 3, there is shown a perspective view of the paddles 14A-14C positioned together to form one embodiment of paddle assembly 10 with the holes 32A-32C and 34A-34C being aligned with corresponding holes 88A-88C and 90A-90C in the paddles 14A-14C. As shown in this view, the paddles 14A-14C may be fastened together to form a cylindrical gripping section 16 with the same shape as the axle 12. However, if the axle 12 had another shape such as being a triangular prism, the edges could be shaped to grip the outer wall of the other shape. They would in the case of a triangular prism be straight so that the three edges together would form a triangle about the triangular prism.

In FIGS. 4 and 5, there are shown simplified perspective views of the paddle 14A viewed from its open side and reverse side respectively. As shown in these views, there are openings in each of the fastener plates 24A, 25A and 27A positioned for fastening together the different paddles on either side about the axle 12 (FIG. 2).

These Figures illustrate the manner in which a rigid hollow member with a substantial moment of inertia to provide strength against twisting may be made inexpensively of simple sheets. Of course, members may even be flexible and extended by centrifugal force or inflatable to provide stiffness or any other mechanism.

With this paddle construction, the paddles 14A-14C in the preferred embodiment may be manufactured so they may be stacked one inside of the other for more compact shipping. Moreover, other parts of the sweeper may be dismantled, folded together and easily shipped. For example, the axle 12 may be formed in parts that are screwed together much in the way of a drilling rig. Thus, it may be shipped in parts and the parts attached one to the other when necessary. Similarly, other bars and the like on the sweeper may be dismantled and packed for convenience. In one embodiment, the sweeper may be folded without completely dismantling.

In FIG. 6, there is shown a plan view of another embodiment of paddle 40 having a flat trapezoidal plate 42 similar to that shown at 18A of FIG. 2, stiffener plates 46 and 48 similar to the stiffener plates 20A and 22A of FIG. 2, a central stiffener plate 44 and apertured fastener plates 50 and 52 similar to the fastener plates 24A and 25A of FIG. 2 on opposite sides of a curved gripping surface. The embodiment of the paddle 40 of FIG. 6 is not a single-walled paddle but is a single thickness paddle. In this specification “single thickness paddle” means a paddle that is a unitary body designed paddle in which all parts of the paddle are walls with substantially the same thickness. The same thickness means that a line through the solid portion of the wall at any location has the same distance between the parallel flat surfaces of its walls.

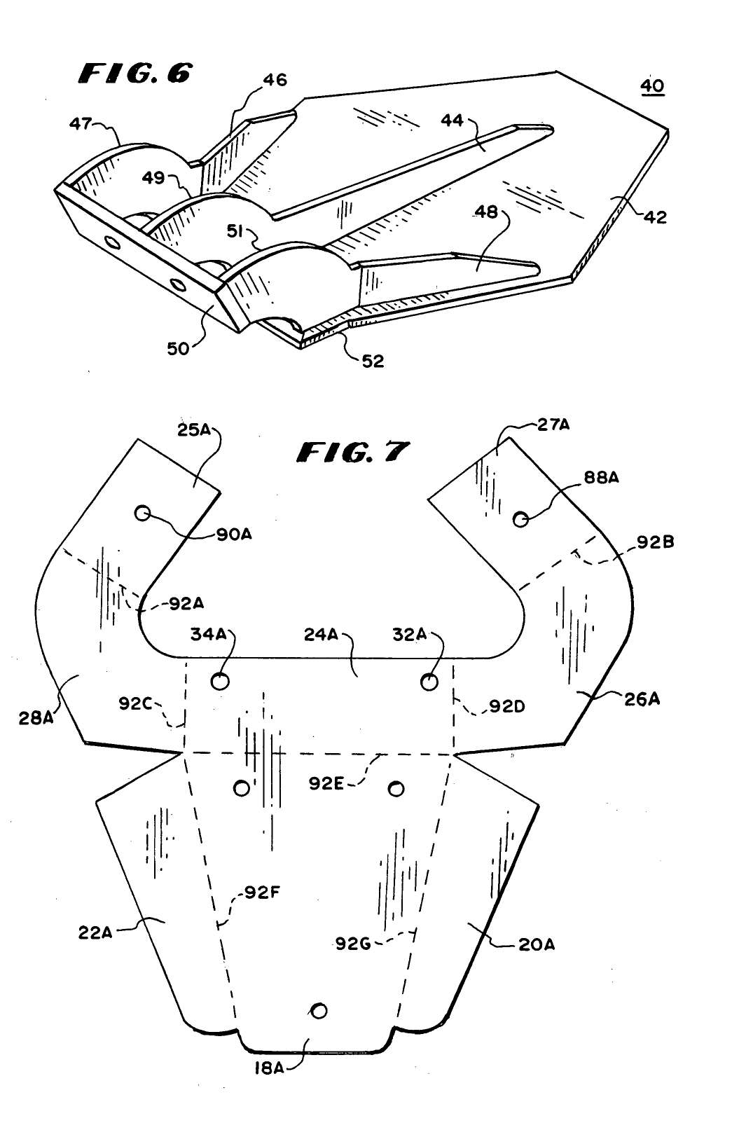

While the embodiment of FIG. 6 includes three stiffener plates 44, 46, and 48 for the base plate 42 and three stiffener plates 47, 49 and 51 for a gripping portion of the paddle, embodiments may have more or fewer stiffener plates as are useful or desirable. Moreover, to enable several stiffener plates to be used at a reduced cost of fabrication, the paddle assembly 40 may be fabricated in a plurality of parts. Additionally, a second base plate with an area larger than the base plate 42 may be fastened to the base plate 42 to provide a longer reach or increased area as well as increased strength. Similarly, two stiffener plates and an additional base plate may be added, thus increasing the paddle base plate area and stiffness. The added stiffener and base plate may also be stamped as a flat sheet from a single-thickness formable sheet material and folded to form transverse side stiffener plates as described in greater detail in connection with FIG. 7 hereinafter.

In FIG. 7, there is shown a steel blank 60 which may be folded to form an embodiment of paddle such as the paddle 14A. With this arrangement, a steel blank may be punched or otherwise formed and folded into a paddle. To bend the blank 60 into a paddle such as the paddle 14A, the blank 60 includes eight sections that are bent around fold lines 92A-92G to form a paddle. The eight sections are: (1) a base plate 18A; (2) two base stiffener plates 20A and 22A which are bent transverse to the base plate at the bend lines 92F and 92G; (3) a first flat fastener plate 24A that is bent at an angle transverse to the base plate 18A about the fold line 92E; (4) two fastener stiffener plates 26A and 28A that are bent about the bend lines 92D and 92C respectively with respect to the first flat fastener plate 24A; and (5) a second flat fastener plate 25A and a third flat fastener plate 27A that are bent about the fold lines 92A and 92B to be transverse to the fastener stiffener plates 26A and 28A.

To fasten the paddles together into a paddle assembly, each of the second and third flat fastener plates 25A and 27A includes a corresponding one of the holes 90A and 88A respectively and the first fastener plate 24A includes the bolt holes 34A and 32A for fastening to the other paddles 14C and 14D. With this arrangement, the base plate 18A forms a wide flat surface that can move refuse from the corn head and which is adapted to cooperate with other paddles to form a self-gripping paddle assembly 10. With this arrangement, the base plate 18A is strengthened by the base stiffener plates 20A and 22A and the end flat plates which increase its moment of inertia. The paddle may be rotated in either direction and nonetheless the principals that lend its stiffness are provided. The particular embodiment of FIG. 7 has the advantage of being easily stacked one on another for shipping if desired.

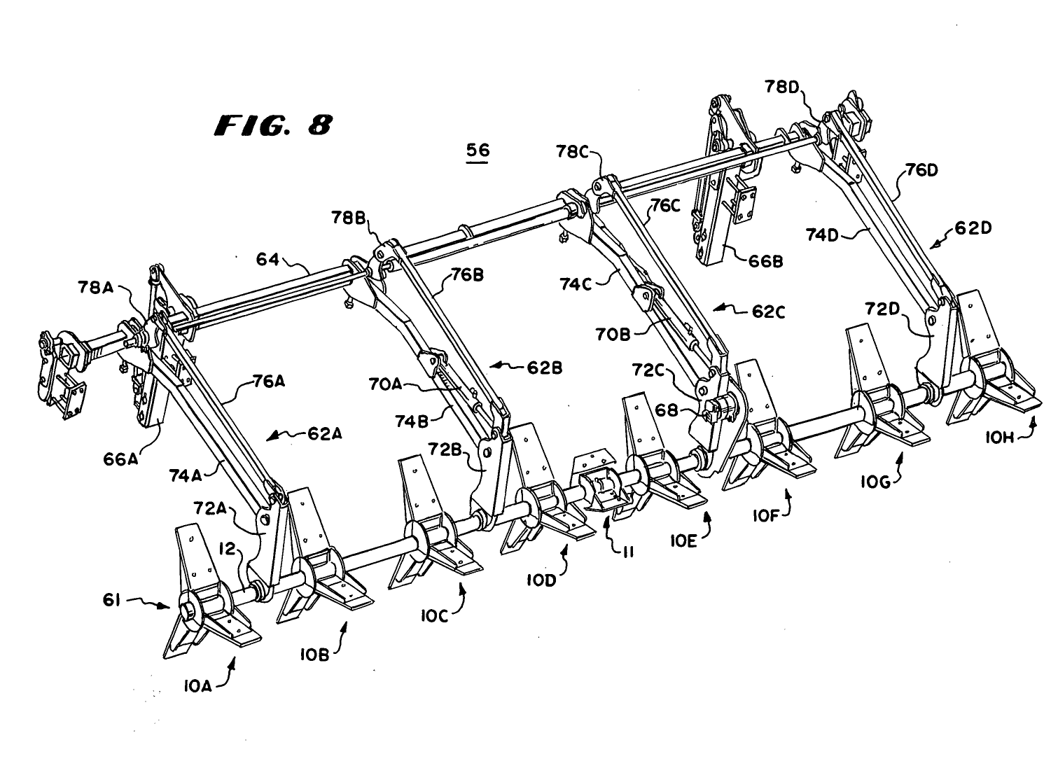

In FIG. 8, there is shown a simplified perspective view of a corn-head sweeper 56 of the type shown in FIG. 1 having an axle-paddle assembly 61, a plurality of sweeper arms 62A-62D, a rear bar 64, two hydraulic cylinders 66A and 66B, and a rotary motor 68 as its principal parts. The axle-paddle assembly 61 includes plurality of self-gripping paddle assemblies 10A-10H, a self-gripping center paddle assembly 11 and an axle 12. The self-gripping paddle assemblies 10A-10H in one embodiment are spaced from each- other along the axle 12 and the center self-gripping paddle assembly 11 is mounted at a central location on the axle 12 where the side augers supply material to the center intake of the combine. The self-gripping paddle assemblies 10A-10H and the center self-gripping paddle assembly 11 rotate over the corn head with the axle 12 to prevent a build up of fluff. The axle 12 is rotated through a chain and sprocket mechanism (not shown in FIG. 8) by the rotary motor 68 which in the preferred embodiment is a hydraulic motor. The paddles and motor are supported together on the axle 12 by the plurality of sweeper arms 62A-62D. The sweeper arms 62A-62D are moved up and down or rocked by the rear bar 64 to which they are attached. The rear bar 64 is driven by the two hydraulic cylinders 66A and 66B so that the self-gripping paddle assemblies 10A-10H can be moved from an elevated position to a position in front of and adjacent to the augers of the corn head.

To move the axle 12 and thus the self-gripping paddle assemblies 10A-10H, the sweeper arms 62B and 62C cooperate with: (1) the rear bar 64; (2) different ones of fore-aft cylinders 70A and 70B; and (3) corresponding main rockers 72B and 72C for fore-aft cylinders 70A and 70B. With this arrangement, the combined motion from the hydraulic cylinders 66A and 66B together with the motion of the fore-aft cylinders 70A and 70B permits positioning of the self-gripping paddle assemblies 10A-10H upwardly above the augers of the corn head 58 mounted to the combine 54 (FIG. 1) to accommodate the harvesting of corn that has been laid over by wind or the like or corn that is standing as described herein above in connection with FIG. 1.

More specifically, each of the sweeper arms 62A-62D includes as its main framework a corresponding one of the main fore-aft lower arm 74A-74D and over fore-aft arm 76A-76D. Each of the main fore-aft lower arms 74A-74D engages the parallelepiped shaped rear bar 64 in a corresponding square opening to move therewith on one of its ends and on the other end is pinned to a corresponding one of the main rockers 72A-72D. Above the main fore-aft lower arms 74A-74D are corresponding ones of the over fore-aft arms 76A-76D each of which is pinned at one end to a corresponding one of the main rockers 72A-72D above the point at which the main fore-aft lower arms 74A-74D are pinned to the corresponding rockers. At the other end, each of the over fore-aft arms 76A-76D is connected to a corresponding one of main rockers for the hydraulic and fore-aft cylinders through a corresponding one of double jointed fasteners 78A-78D. Each of the double jointed fasteners 78A-78D is pinned at one end to a corresponding one of the main fore-aft lower arms 74A-74D and at its other end to a corresponding one of the over fore-aft arms 76A-76D. With this arrangement, two centers of rotation are provided to permit the orbiting of the self-gripping paddle assemblies 10A-10H and the self-gripping center paddle assembly 11 from an active sweeping position to an elevated position away from the corn heads but located to permit good visibility for the operator of the combine. A first center of rotation is provided by the parallelepiped rear bar 64 and a second center of rotation is provided by the rockers 72A-72D at their inner pivot points.

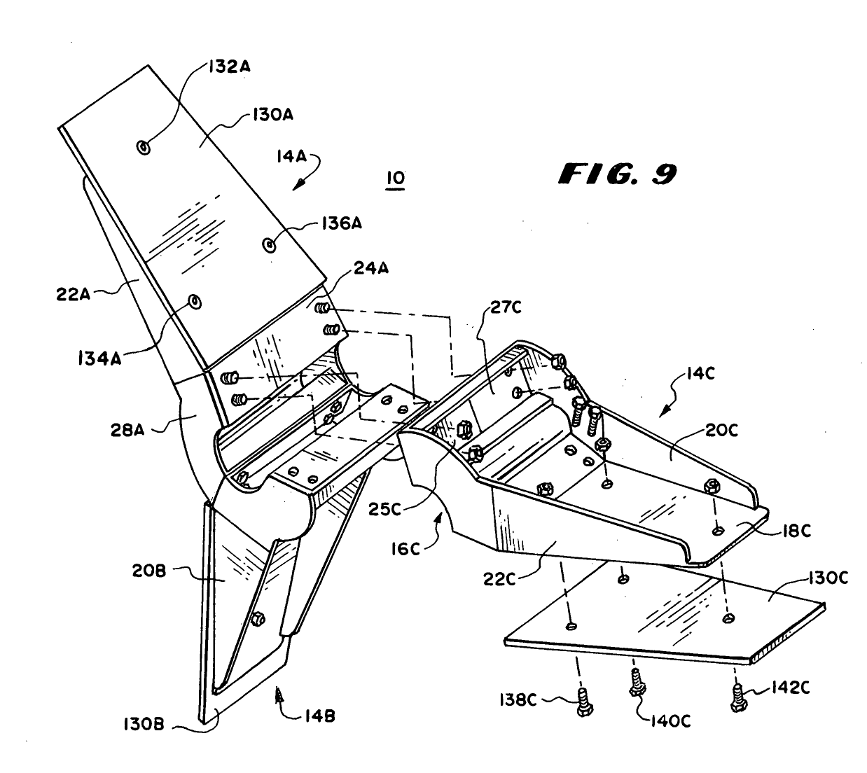

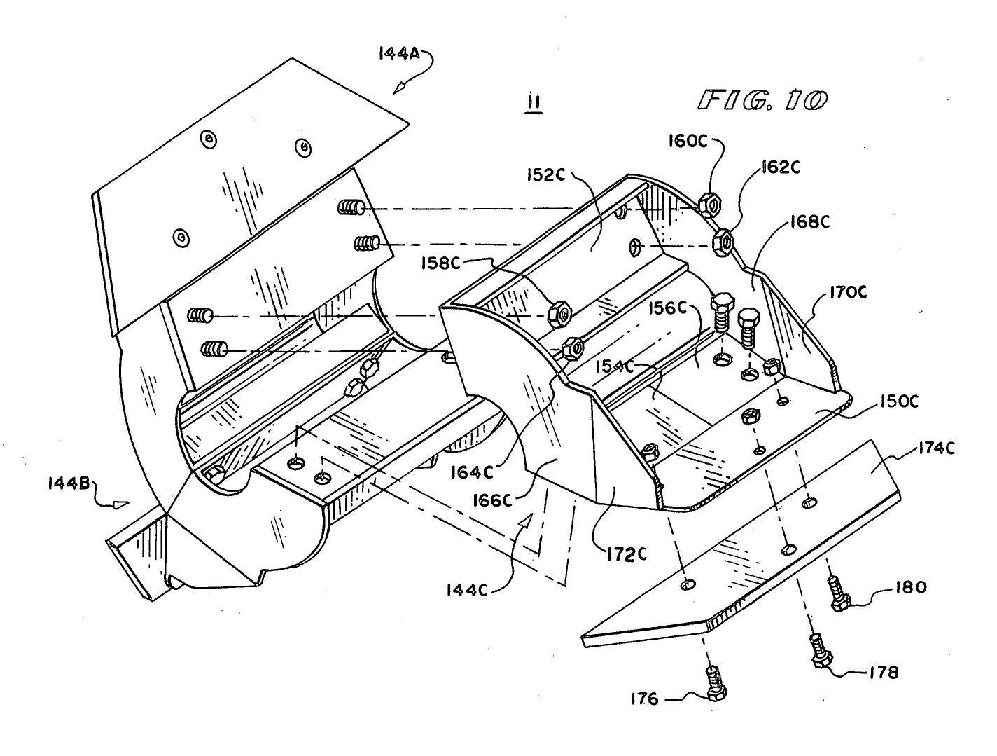

In FIG. 9, there is shown another simplified perspective view of a self-gripping paddle assembly 10 that is identical to the self-gripping paddle assembly 10 shown in FIG. 2 and has similar numbered parts except that the view in FIG. 9 includes three additional base plates 130A-130C which are bolted to the base plates 18A-18C but include a longer length to increase the reach of the paddles where desired. For this purpose, each of the second base plates 130A-130C has a set of holes shown at 132A, 134A and 136A for the paddle 14A that correspond in location to match the opening 122A, 124A and 126A such as those shown in 18A of FIG. 2. Similarly, the other paddles 14A-14C are adapted to have plates attached such as by rivets or bolts or any other fastening means, three of which are as shown at 138C, 140C and 142C with respect to the paddle 14C.

In FIG. 10, there is shown a simplified exploded view of the self-gripping center paddle assembly 11 of FIG. 8 having paddles 144A, 144B and 144C. The paddles 144A-144C are identical so only the paddle 144C will be described in detail.

The paddle 144C includes a base plate 150C, three fastener plates 152C, 154C and 156C and four stiffener plates 166C, 168C, 170C and 172C. The stiffener plates 166C and 168C have gripping edges for the axle similar to the embodiment 10 of FIG. 2. The fastener plate 154C of the paddle 144C is bolted to the fastener plate of paddle 144A by four bolts 158C, 160C, 162C and 164C. The only difference is that the base plate 150C in the embodiment of FIG. 10 is much shorter and of different shape so that it may rotate above the corn head without as long a reach into the corn head. As in the embodiment of FIG. 9, a second base plate such as that shown at 174C may be bolted to the base plate such as shown at 150C bolted with bolts 176C, 178C and 180C. Similarly, second base plates with a longer length may be bolted to the corresponding base plates of the paddles 144A and 144B by means of bolts to increase their length as needed.

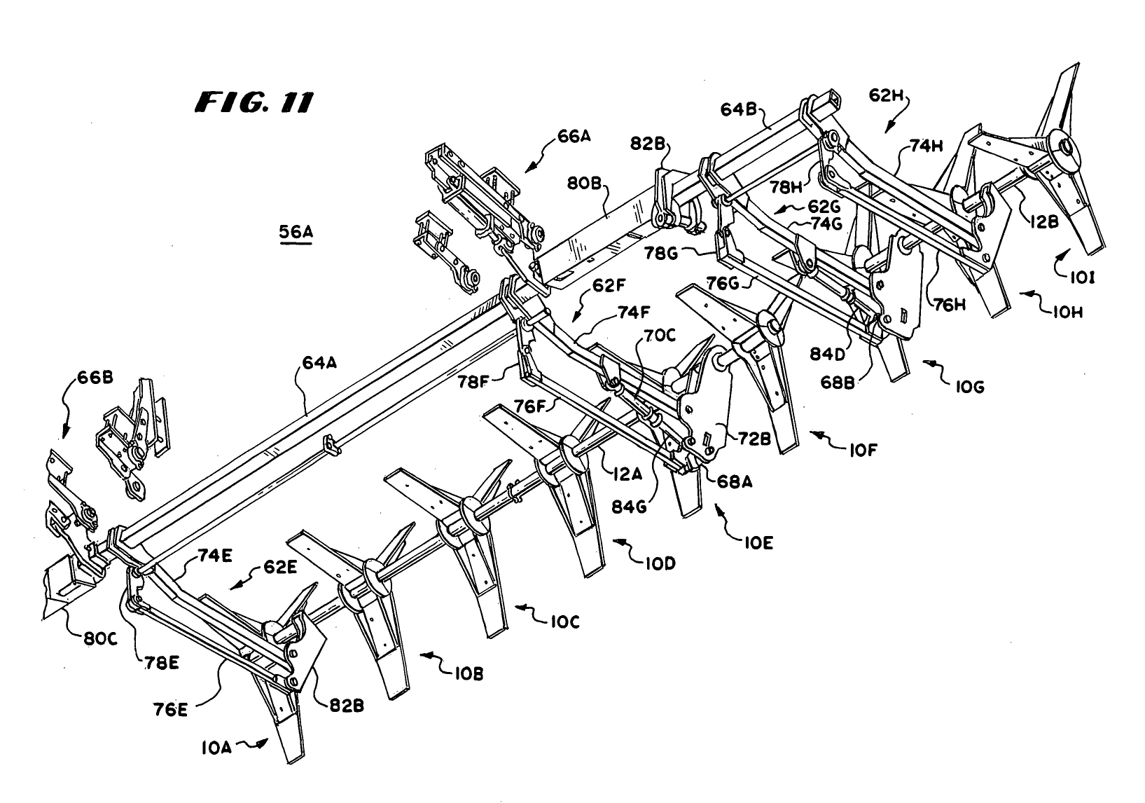

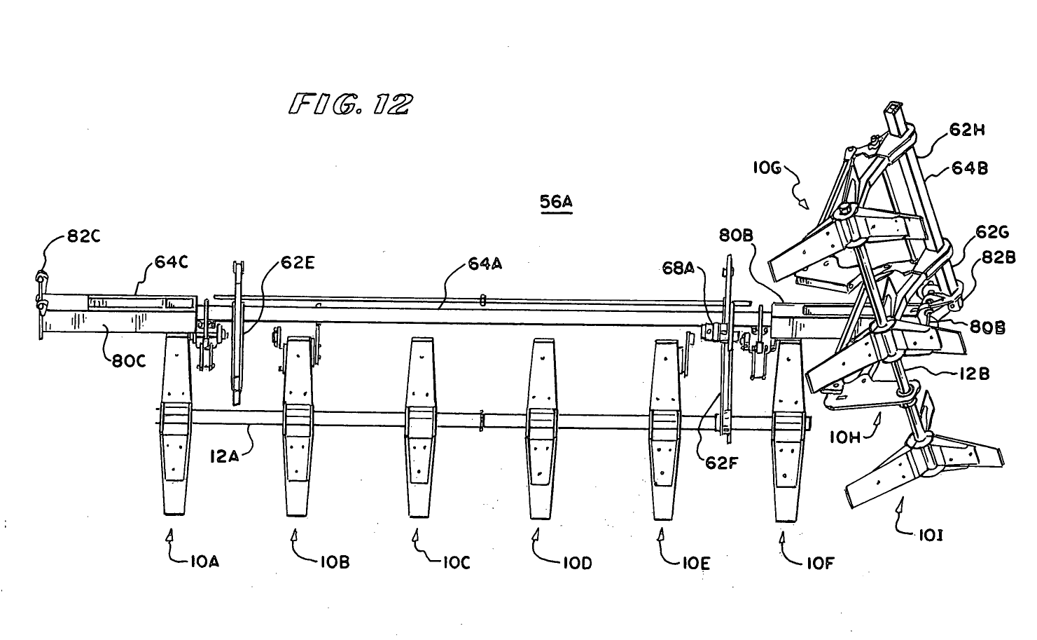

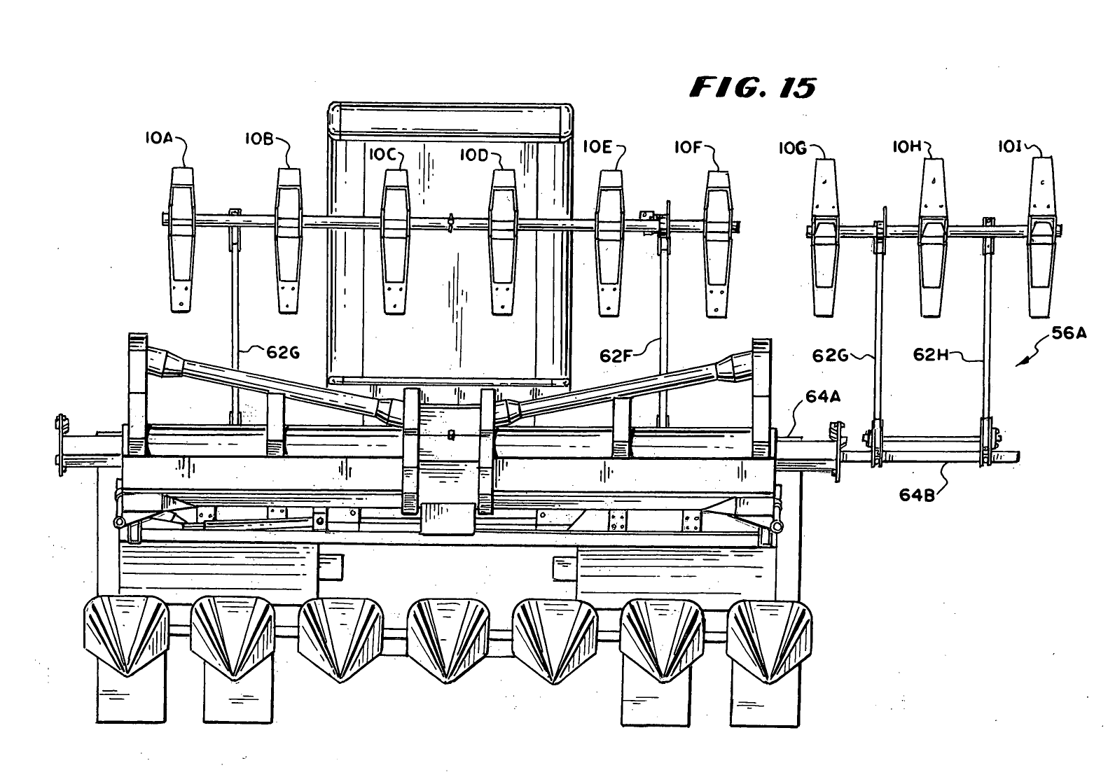

In FIGS. 11 through 15, there are shown simplified perspective views of another embodiment of corn-head sweeper 56A. The corn-head sweeper 56A can operate with a plurality of paddles aligned along axle sections 12A and 12B as shown in FIGS. 11 and 15 but also can be folded as shown in FIGS. 12, 13 and 14. In addition, the corn-head sweeper may be dismantled and broken down into smaller units with a reduced size. In one embodiment, the axle sections 12A and 12B and the rear bar sections such as the sections 64A and 64B can be disconnected. Moreover, additional paddles may be added with other sections in a manner similar to that illustrated in FIGS. 11 through 15. To enable the sweeper to be broken down into sections, the rear bar is divided into three sections 64A, 64B and 64C in the embodiment of FIGS. 11 through 15. The section 64A is the main section and the section 64B is adapted to be folded as shown in FIG. 12 or to provide a convenient location for separation. In the embodiments of FIGS. 11 through 15, additional paddle sections are not provided to cooperate with the section 64C but such sections can be provided in a manner similar to the section 64B.

To change the configuration of the corn-head sweeper or dismantle it for shipment, the sections 64C (shown in FIG. 12) and 64B (shown in FIGS. 11-15) can be added or removed from opposite ends of the rear bar section 64A. To permit this addition and removal of sections, one end of a sleeve 80B (shown in FIGS. 11 and 12) fits over one end of the rear bar section 64A and the other end of the sleeve 80B receives one end of the rear end bar section 64B. Similarly, one end of a sleeve 80C (best shown in FIGS. 11 and 12) may fit over the other end of the rear bar section 64A to receive a section of the rear bar (not shown) if desired. At the distal end of the sleeve 80B, there is a hinge 82B (shown in FIG. 12) and at the distal end of the sleeve 80C, there may be a hinge (not shown) to permit folding of the end rear bars 64B and 64C. Moreover additional sleeves and hinges may be provided to which additional square bars may be attached.

The axle sections 12A and 12B are formed in two parts to cooperate with the two sections 64A and 64B of the rear bar in the embodiments of FIGS. 11 through 15. In the embodiments of FIGS. 11 through 15, the sections of axle 12A and 12B are separate from each other and independently supported from the respective portions of the rear bars 64A and 64B. They each support a plurality of paddles to form an elongated corn-head sweeper. However, in other embodiments, they may be fastened together to conserve drive motors. The axle section 12A is supported by two sweeper arms 62E and 62F in a manner similar to that of the embodiment of FIG. 8 and the axle section 12B is similarly supported by the two sweeper arms 62G and 62H. Each of the sweeper arms engages the respective rear bars 64A and 64B at one end and the axle sections 12A and 12B at the other end. They are formed in two sections to provide stiffness, with the sections being separated along the length of the bars.

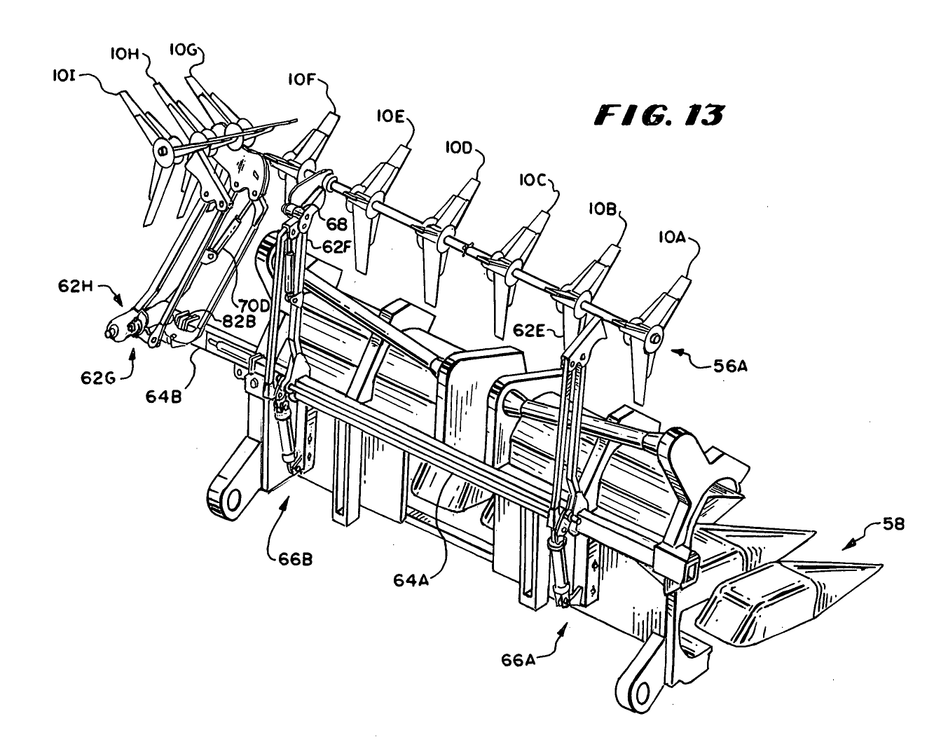

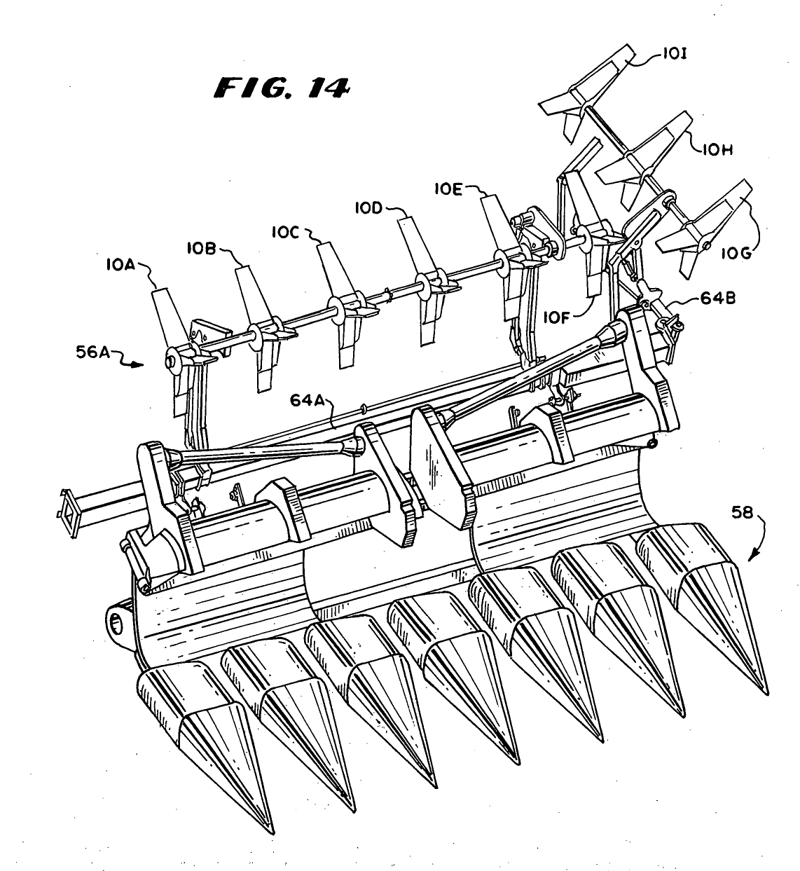

Hydraulic cylinders 66A and 66B (shown in FIGS. 11 and 13) are mounted to the rear bars 64A and 64B in a manner similar to the embodiment of FIG. 8 to position the paddle. Hydraulic rotary motor 68A and 68B (shown in FIG. 11), one for each of the axle sections 12A and 12B are mounted to rotate the axle sections. Similarly, two fore-aft hydraulic cylinders 70C (FIG. 11) and 70D (FIG. 13) are mounted to actuate the sweeper arms 62F in connection with the axle section 12A and rear bar 64A as shown in FIG. 11, and sweeper arm 62G in connection with the axle section 12B and the rear bar 64B as shown in FIG. 13 and as described above in connection with FIG. 8. Sweeper arms 62E, 62F, 62G and 62H (shown in FIG. 11) have respective ones of the main fore-aft lower arms 74E-74H, over fore-aft arms 76E-76H and double jointed fasteners 78E-78H respectively to operate in a manner similar to that of the embodiment of FIG. 8. In FIGS. 13-15, the corn-head sweeper 56A is shown mounted to the corn head 58. In FIGS. 13 and 14, it is shown in an elevated position, with the end rear bar 64B pivoted about the hinge 82B (FIG. 13) to pivot the self-gripping paddle assemblies 10G-10I at an angle to the self-gripping paddle assemblies 10A-10F. In FIGS. 11 and 15, the paddles 10A-10I are aligned and the rear end bars are aligned.

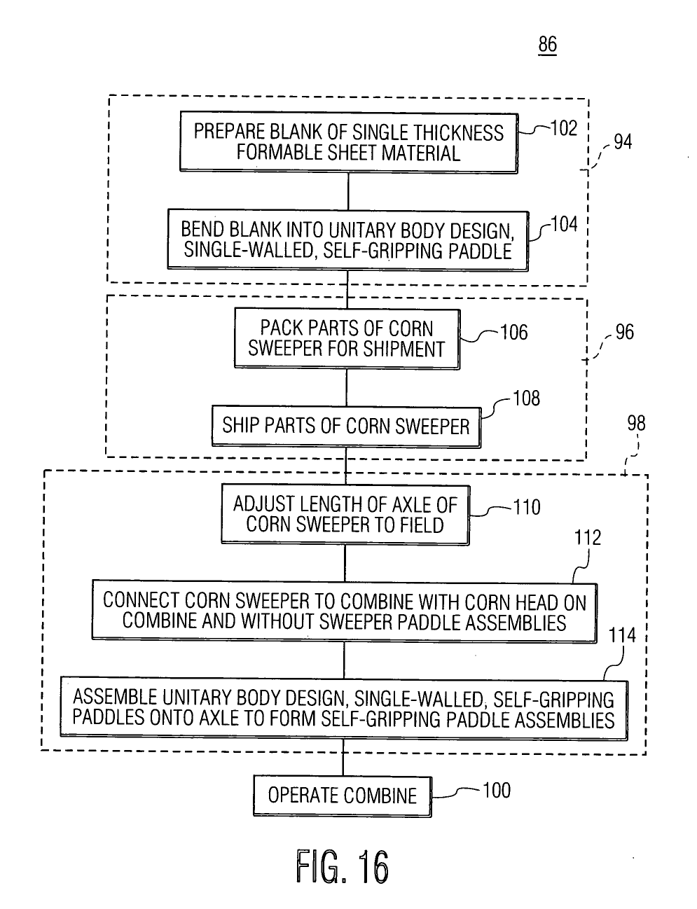

In FIG. 16, there is shown a fragmentary flow diagram 86 of a process of making and using a corn-head sweeper with single-walled paddles, including the step 94 of preparing self-gripping paddle assemblies such as the paddle 14A, the step 96 of shipping a corn sweeper including the self-gripping paddle assemblies, the step 98 of assembling the corn-head sweeper to a combine and the step 100 of operating the combine together with a corn head and the corn-head sweeper. The step 94 includes as its principal substeps, the substep 102 of preparing a blank of single thickness formable sheet material and the substep 104 of bending the blank into a unitary body design, single-walled, self-gripping paddle. The step 104 forms a single-walled paddle in accordance with one embodiment of the invention such as the paddle 14A of FIGS. 2-5, with minor modifications in the process of making the paddle, and another embodiment of paddle such as paddle 40A of FIG. 6 which has a plurality of stiffener walls 44, 46 and 48, which may be made separately or formed together with the base plate 42.

Any number of stiffeners may be used as appropriate for the particular field conditions and the size of the base plate, which will be related to the strain requiring a higher moment of inertia. Moreover, the strain imposed on a single base plate may be reduced by combining or locating several base plates with their own stiffener plates adjacent to each other to share the stress. In such an embodiment, the additional base plates with stiffeners, may be made by stamping out a plate of formable, single thickness material and folding it into a base plate with side stiffeners as described above in connection with FIG. 7.

The step 96 of shipping a corn sweeper including the paddle includes as its principal substeps the substep 106 of packing the parts of the corn sweeper for shipment and the substep 108 of shipping the parts of the corn sweeper. In some embodiments, the paddle parts are made for stacking one in the other for compactness. The axle may be dismantled such as by unscrewing or may be folded for shipment depending upon the particular embodiment of corn-head sweeper.

The step 98 of assembling the corn sweeper to a combine having a corn head on it includes as its principal substeps the substep 110 of adjusting the length of the axle of the corn sweeper to accommodate the field, the substep 1 12 of connecting the corn sweeper to a combine with a corn head on the combine and without the sweeper paddle assemblies and the substep 114 of assembling unitary body design, single-walled, self-gripping paddles onto an axle such as the axle 12 to form a self-gripping paddle assembly. The length of the axle may be adjusted by screwing sections together or by folding. The corn sweeper is connected to a corn head in a combine through hinges and may be lifted to a lower position or a higher position by hydraulic cylinders or other motor means to accommodate different stands of corn. For example, if corn has been knocked down by a hail storm, the corn sweeper may be lowered during harvesting and if the cornstalks are standing, the corn sweeper may be raised so that they function to remove debris from the corn head. The process 86 of making and using the corn sweeper includes the step 100 of operating the combine in accordance with the particular nature of the field.

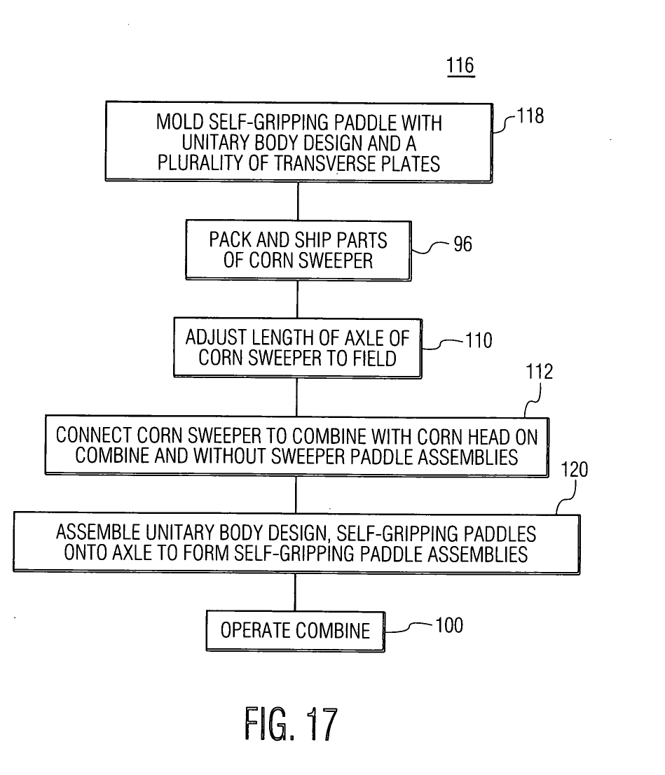

In FIG. 17, there is shown a flow diagram 116 of a process of making and using a corn-head sweeper that includes paddles that are not single-walled paddles and instead have walls extending from the base plate between the side stiffener walls. The process shown in the flow diagram 116 includes the step 118 of molding self-gripping paddle with the unitary body design and a plurality of transverse plates, the step 96 of packing and shipping the parts of the corn sweeper, the step 110 of adjusting the length of the axle of the corn sweeper to accommodate the field, the step 112 of connecting the corn sweeper to the combine with the corn head on the combine and without the sweeper paddle assemblies, the step 120 of assembling a unitary body design, self-gripping paddles onto the axle at proper locations to accommodate the field to form a self-gripping paddle assemblies, and the step 100 of operating the combine. The process illustrated in the flow diagram 116 differs from the process illustrated by the flow diagram 86 of FIG. 16 in that the paddle assemblies may include some paddles that are not single-walled paddles. It may include only molded paddles with extra transverse walls or a combination of single-walled paddles and paddles that have transverse walls to form the paddle assemblies. This will slightly change the manner in which the parts are packaged for shipment but otherwise on a combine will operate in all important manners substantially the same.

From the above description, it can be understood that the self-gripping paddle assembly of this invention has several advantages, such as for example: (1) it may be quickly and easily assembled to a drive mechanism; (2) it does not require a separate fastening hub that is connected to the drive mechanism; (3) the individual parts may be easily manufactured because of their simplicity; (4) the paddles are structurally strong with a high moment of inertia; (5) the parts may be conveniently packed for shipment with other parts of the sweeper, some of which may also be dismantled; (6) the assembly may be part of a retrofitted design for a corn harvester; and (7) the paddles may be easily assembled about an axle of the sweeper without disassembling the sweeper.

Although a preferred embodiment of the invention has been described with some particularity, many modifications and variations of the preferred embodiment may be made without deviating from the invention. Accordingly, within the scope of the appended claims, the invention may be practiced other than as specifically described.

What is claimed is:

1. A corn head sweeper comprising:
an elongated axle;
a plurality of self-gripping paddle assemblies spaced along the elongated axle;
a transmission connected to the elongated axle and adapted to be driven by a motor to rotate the elongated axle;
the plurality of self-gripping paddle assemblies being mounted to said axle to be orbited thereby wherein the plurality of self gripping paddle assemblies are orbited by the elongated axle.

2. A corn head sweeper in accordance with claim 1 wherein at least one of said plurality of self-gripping paddle assemblies includes single-walled paddles having a unitary body design.

3. A corn head sweeper in accordance with claim 1 wherein at least one of said self-gripping paddle assemblies includes paddles that are single thickness paddles.

4. A corn head sweeper in accordance with claim 1 wherein the plurality of self-gripping paddle assemblies have a plurality of walls wherein one of said walls being a base plate substantially in the same plane as an axis of rotation and having a plurality of stiffener plates substantially orthogonal to the base plate.

5. A corn head sweeper in accordance with claim 1 wherein at least one unitary body design paddle includes a flat base plate and a plurality of stiffener plates transverse to the flat base plate to provide a rigid paddle with a relatively high moment of inertia.

6. A corn head sweeper in accordance with claim 1 wherein the plurality of self-gripping paddle assemblies each comprises a plurality of paddles which cooperate with each other and with the axle to form a self-gripping paddle assembly fastened to the axle.

7. A corn head sweeper in accordance with claim 6 wherein the plurality of paddles have edges wherein, when the plurality of paddles are connected together, the edges grip the axle.

8. A corn head sweeper in accordance with claim 1 wherein at least one unitary body design paddle is a single-walled paddle.

9. A corn head sweeper in accordance with claim 4 wherein at least some of said plurality of stiffener plates are connected to and integrally formed with different edges of the base plate.

10. A method of preventing debris from impeding operation of corn harvesting equipment comprising the steps of:
positioning a sweeper in the path of debris wherein the sweeper includes self-gripping paddle assemblies;
operating the corn harvesting equipment; and
rotating the sweeper so that the self-gripping paddle assemblies reduce accumulation of debris on a corn head.

11. A method in accordance with claim 10 wherein the step of positioning a sweeper in the path of debris comprises the step of positioning a sweeper including self-gripping paddle assemblies with unitary body design paddles in the path of debris.

12. A method in accordance with claim 11 wherein the step of positioning a sweeper in the path of debris includes the step of positioning the sweeper in the path of debris wherein at least one of the self-gripping paddle assemblies includes a single-thickness paddle.

13. A method in accordance with claim 11 wherein the step of positioning a sweeper in the path of debris includes the step of positioning the sweeper in the path of debris wherein at least one of the self-gripping paddle assemblies includes a paddle having a base plate and a plurality of stiffener plates extending transverse to and from said base plate.

14. A method in accordance with claim 11 wherein the step of positioning a sweeper in the path of debris includes the step of positioning the sweeper in the path of debris wherein at least one of the self-gripping paddle assemblies includes a paddle having a base plate and at least three stiffener plates extending tranverse to and from said base plate.

15. A method in accordance with claim 11 wherein the step of positioning a sweeper in the path of debris includes the step of positioning the sweeper in the path of debris wherein at least one of the self-gripping paddle assemblies includes a single-walled paddle formed from formable sheet material.

16. A method in accordance with claim 11 in which the step of positioning a sweeper includes the substeps of positioning the self-gripping paddle assemblies to correspond with rows of corn; and positioning the sweeper to be positioned in accordance with the position of corn stocks wherein debris is prevented from impeding harvesting for both upright corn stocks or bent corn stocks.

17. A method in accordance with claim 11 further including the step of locating self contained paddles in the sweeper including the sub steps of loosening elements of the self-gripping paddle assemblies from each other, moving the elements to a new location and tightening the elements wherein they grip a drive axle of the sweeper.

18. A method of making a self-gripping paddle assembly comprising the steps of:
obtaining sheet metal;
forming the sheet metal into paddles having sides transverse to each other and punched openings for fastening the paddles together, whereby a high inertia inexpensive paddle is formed; and
assembling the paddles into a self-gripping paddle assembly.

19. A method in accordance with claim 18 further including the step of folding side portions of a blank transverse to a base portion to form stiffeners for the base portion whereby the paddles are stiffened.

20. A method of shipping a component of a sweeper comprising the steps of:
inserting a group of paddles one inside of the other;
dismantling an axle; and
packing the axle, the paddles and other parts in a single shipping container and shipping it.

21. A method in accordance with claim 20 in which the paddles are injection molded.

22. A method in accordance with claim 20 in which the paddles are stamped from metal and folded.
